(19) United States
(12) Patent Application Publication
(10) Pub. No.: US 2009/0075139 A1
(43) Pub. Date: Mar. 19, 2009

(54) NANOPOROUS/MESOPOROUS PALLADIUM CATALYST

(75) Inventors: Anthony Kucernak, London (GB); Junhua Jiang, Chicago, IL (US)

Correspondence Address: CHOATE, HALL & STEWART LLP, TWO INTERNATIONAL PLACE, BOSTON, MA, 02110, US

(73) Assignee: IC INNOVATIONS LIMITED, London (GB)

(21) Appl. No.: 10/585,015

(22) PCT Filed: Jan. 5, 2005
(86) PCT No.: PCT/GB2005/000002

§ 371 Date: Dec. 3, 2008

(51) Int. Cl. C25B 11/03; H01M 8/10; G01N 27/26; B01J 23/44; B01J 23/40; B01J 23/58; B01J 23/72; B01J 27/24; B01J 27/20; B01J 27/185; B01J 27/057; B01J 27/045; B01J 23/00; B01J 37/30

(52) U.S. Cl. 429/30; 204/284; 204/416; 205/787; 205/792.5; 502/339; 502/326; 502/330; 502/331; 502/200; 502/174; 502/213; 502/215; 502/223; 502/313; 502/11

(57) ABSTRACT

The present invention provides a catalytic system comprising a catalyst comprising nanoporous or mesoporous palladium and an ion-exchange electrolyte, processes for manufacturing the catalytic system and catalyst, and processes for oxidising or reducing organic and/or inorganic molecules using the catalyst or catalytic system.

### PRIORITY

This Application claims the benefit under 35 U.S.C. § 371 of International Application No.: PCT/GB2005/000002 (published PCT application No. WO 2005/067082), filed Jan. 5, 2005, which claims priority to G. B. Patent Application No.: 0400166.5 filed Jan. 6, 2004; the entire contents of each of the above-referenced applications are incorporated herein by reference.

### FIELD OF THE INVENTION

The present invention relates to a catalytic system comprising a catalyst comprising nanoporous or mesoporous palladium and an ion-exchange electrolyte. The invention also provides a multi-component catalyst which comprises nanoporous or mesoporous palladium and one or more additional components. Also provided are processes for manufacturing the catalytic system and catalyst, and a process for oxidising or reducing organic and/or inorganic molecules using said catalyst or catalytic system. The invention further relates to an electrode comprising the catalyst or the catalytic system, and also a fuel cell or a sensor comprising the catalyst, the catalytic system or the electrode.

### BACKGROUND OF THE INVENTION

There has been much interest in the development of fuel cells and sensors in the past decades. The development of such fuel cells and sensors has been highly dependent upon the use of catalysts for the oxidation of H₂, small organic molecules and hydrocarbons, as well as for the reduction of O₂. Catalysts for the oxidation of molecules such as H₂, small organic molecules and hydrocarbons, etc are typically noble metals in dispersed form. For the reduction of oxygen, the most active catalyst is considered to be one composed of PtCr spherical or cubo-octahedral particles supported on carbon, (T. R. Ralph and M. P. Hogarth, Platinum Metals Review, 2002, 46, (1), 3-14) whereas for pure hydrogen, the most active catalyst is Pt spherical or cubo-octahedral particles also supported on carbon. For the oxidation of reformate (hydrogen containing some carbon monoxide), the preferred catalyst is one composed of PtRu or PtMo spherical or cubo-octahedral particles supported on carbon particles (T. R. Ralph and M. P. Hogarth, Platinum Metals Review, 2002, 46, (3), 117-135) whereas for the oxidation of methanol, and similar small organic molecules, the preferred catalyst is PtRu alloy in the form of small particles either unsupported or supported upon carbon particles (T. R. Ralph and M. P. Hogarth, Platinum Metals Review, 2002, 46, (4), 146-164).

Within the current art, typical electrodes consist of a gas diffusion substrate with platinum-based (Pt) electrocatalyst layers located between the ion-exchange membrane electrolyte and the substrate. The electrocatalyst can be deposited either on the gas diffusion substrate or on the ion-exchange membrane electrolyte using techniques such as screen printing, flexographic printing, gravure printing, spraying or rolling and calendering. Electrocatalyst layers are typically from 5 to 20 μm thick and the layers are normally bonded together by hot pressing catalysed substrates to the membrane or, in the case of catalysed membranes, by compressing the gas diffusion substrate to the membrane (T. R. Ralph and M. P. Hogarth, Platinum Metals Review, 2002, 46, (1), 3-14).

Virtually all catalysts for low temperature polymer electrolyte fuel cells (PEMFC) or electrochemical sensors utilise platinum as the major catalyst component, optionally alloyed with other species. Palladium has been considered as an alloying component but the performance of a platinum catalyst containing palladium based on current production methods is exceedingly poor, requiring 300 mV extra overpotential to function at the same rate as a PtRu catalyst. As a result, such palladium containing catalysts would not normally be considered suitable for use as an electrocatalyst in a fuel cell or sensor.

In these previous cases, the catalysts exist in the form of fully dense nanoparticles—i.e. particles with a spherical or cubo-octahedral morphology with diameters ranging from about 1 nm to 10 nm, possibly deposited on an electrically conducting but catalytically inactive support (e.g. carbon). The small dimensions of these particles are necessary to have a high surface area to volume ratio. An alternate structure to this involves catalyst materials which are not fully dense, but rather which have a mesoporous or nanoporous structure. Such materials may have a range of morphologies—e.g. spherical, cylindrical, film-like—but rather than being fully dense, they are porous and thus can still have a high surface area to volume ratio, even though the primary particle size is much larger than the fully dense particles currently used as catalysts. Examples of methods for making nanoporous or mesoporous materials include using templates such as a surfactant or mesoporous silicon. Other examples involve the use of a sol-gel synthesis route, the use of microemulsions or the use of metallo-organic chemical vapour deposition (MOCVD).

As is described in this invention, for certain specific morphologies of palladium and palladium containing catalysts, and in contact with specific types of electrolytes, the performance of these catalysts may be significantly higher than might be expected by comparison to catalytic systems containing palladium and/or palladium containing catalysts produced using standard approaches.

### SUMMARY OF THE INVENTION

In a first aspect, the present invention provides a catalytic system comprising a catalyst comprising nanoporous or mesoporous palladium and an ion-exchange electrolyte.

In certain embodiments of the first aspect, the catalyst further comprises one or more of platinum, gold, ruthenium, rhodium, osmium, iridium, silver, nickel, copper, cobalt, iron, chromium, lead, vanadium or tungsten. In certain other embodiments, the catalyst is Pd, PdPt, PdAu, PdPtRu, PdPtIr, PdPtAu, PdPtRuIr, PdPtRuOs or PdPtRuIrOs.

In certain other embodiments of the first aspect, the ion-exchange electrolyte is a cation exchange electrolyte.

In a second aspect, the present invention provides a multi-component catalyst comprising a nanoporous or mesoporous palladium and one or more of platinum, gold, ruthenium, rhodium, osmium, iridium, silver, nickel, copper, cobalt, iron, chromium, lead, vanadium, tungsten, carbon, nitrogen, oxygen, sulphur, selenium, tellurium or phosphorous.

In a third aspect, the present invention provides a process for the production of a catalyst of the second aspect of the invention, wherein the process comprises solidifying one or more metal precursors in the presence of a templating agent and then removing the templating agent.

In a fourth aspect, the present invention provides a process for the oxidation or reduction of inorganic and/or organic molecules comprising contacting the molecules with a catalytic system of the first aspect of the invention, or a multi-component catalyst of the second aspect of the invention.

In certain embodiments of the fourth aspect, the organic molecule has from one to twelve carbon atoms. In certain other embodiments, the organic molecule is methanol.

In certain embodiments of the fourth aspect, in the catalytic system, the catalyst is Pd, PdPt, PdAu, PdPtRu, PdPtIr, PdPtAu, PdPtRuIr, PdPtRuOs or PdPtRuIrOs. In certain embodiments, in the catalytic system, the ion-exchange electrolyte is a cation exchange electrolyte.

In a fifth aspect, the present invention provides a process for the manufacture of a catalytic system of the first aspect of the invention, which process comprises contacting the catalyst with the ion-exchange electrolyte.

In certain embodiments of the fifth aspect, in the catalytic system, the catalyst is Pd, PdPt, PdAu, PdPtRu, PdPtIr, PdPtAu, PdPtRuIr, PdPtRuOs or PdPtRuIrOs. In certain other embodiments, in the catalytic system, the ion-exchange electrolyte is a cation exchange electrolyte.

In a sixth aspect, the present invention provides an electrode comprising a catalytic system of the first aspect of the invention, or a multi-component catalyst of the second aspect of the invention.

In certain embodiments of the sixth aspect, in the catalytic system, the catalyst is Pd, PdPt, PdAu, PdPtRu, PdPtIr, PdPtAu, PdPtRuIr, PdPtRuOs or PdPtRuIrOs. In certain other embodiments, in the catalytic system, the ion-exchange electrolyte is a cation exchange electrolyte.

In a seventh aspect, the present invention provides a fuel cell comprising an electrode of the sixth aspect of the invention.

In certain embodiments of the seventh aspect, in the catalytic system, the catalyst is Pd, PdPt, PdAu, PdPtRu, PdPtIr, PdPtAu, PdPtRuIr, PdPtRuOs or PdPtRuIrOs. In certain other embodiments, in the catalytic system, the ion-exchange electrolyte is a cation exchange electrolyte.

In an eighth aspect, there is provided a sensor comprising an electrode of the sixth aspect of the invention.

In certain embodiments of the eighth aspect, in the catalytic system, the catalyst is Pd, PdPt, PdAu, PdPtRu, PdPtIr, PdPtAu, PdPtRuIr, PdPtRuOs or PdPtRuIrOs. In certain other embodiments, in the catalytic system, the ion-exchange electrolyte is a cation exchange electrolyte.

In a ninth aspect, there is provided a method for the detection of organic and/or inorganic molecules in a sample comprising contacting said sample with a sensor of the eighth aspect of the invention and detecting the current due to the oxidation or reduction of the molecules.

### BRIEF DESCRIPTION OF THE DRAWING

FIG. 1 shows SEM image and TEM image (inset) of Palladium mesoporous film electrochemically deposited on a gold foil at 0.16 V vs Ag/AgCl for 4 hr with a charge of 20 C cm⁻².

FIG. 2 shows high resolution scanning electron micrograph images of PtPdRuOs alloy chemically prepared from a liquid crystal phase, (A). Transmission electron micrograph (TEM) images of PtPdRuOs nanoparticles, (B). TEM images of a single PtPdRuOs particle, (C). Electron diffraction patterns of aggregated PtPdRuOs nanoparticles (D)

FIG. 3 shows cyclic voltammograms for a mesoporous (a) and polycrystalline (b) Palladium disc microelectrode in 0.1 mol dm⁻³ HClO₄+1 mol dm⁻³ methanol (dash line) and on a Nafion™ membrane equilibrated with 1 mol dm⁻³ methanol in water (solid line) at 20° C. (dE/dt: 50 mV s⁻¹):

FIG. 4 shows steady-state voltammograms for microelectrodes composed of mesoporous palladium, mesoporous PdPtRu and mesoporous PdPtRuOs catalysts on a Nafion™ membrane equilibrated with 1 mol dm⁻³ CH₃OH in water (a); and for mesoporous palladium on a Nafion™ membrane equilibrated with 0.15 mol dm⁻³ HCOOH in water and 0.20 mol dm⁻³ HCHO in water, (b).

FIG. 5 shows steady-state voltammograms measured at 5 mV s⁻¹ for a microelectrode containing mesoporous PtPdRuOs catalyst on a Nafion membrane equilibrated with 1 mol dm⁻³ methanol in water at various temperatures. Inset: Potential dependence of mass activity of the quaternary alloy at 20 and 60° C. Data taken from the positive-going scans.

FIG. 6 shows a plot of limiting current versus methanol concentration (in water) for a mesoporous palladium catalyst/Nafion™ membrane catalyst system.

### DETAILED DESCRIPTION OF CERTAIN PREFERRED EMBODIMENTS OF THE INVENTION

In a first aspect, the invention herein described provides a catalytic system comprising a catalyst comprising nanoporous or mesoporous palladium and an ion-exchange electrolyte.

In certain embodiments, the catalyst as described in this invention exists as a bulk material that comprises palladium having a nanoporous or mesoporous morphology. It is these pores that contribute to the large specific surface area of the catalyst. The pore size may range in diameter from about 0.75 nm to about 50 nm, preferably about 0.75 to about 20 nm, and more specifically about 1 to about 10 nm diameter. The distance separating the pores follows a similar range.

The catalytic system of the first aspect provides improved performance compared with previously reported systems containing palladium containing catalysts.

It is hypothesised that the improvement in activity of the catalytic system of the present invention over other palladium containing catalytic systems is related to an alteration in the formation of adsorbed oxygen-containing species on the catalyst. This modification of adsorption properties may be the result of an interaction between the nanoporous or mesoporous structure of the catalyst with the ion-exchange electrolyte.

In a preferred feature, the palladium catalyst comprises nanoporous or mesoporous palladium with one or more additional components so as to form a multi-component catalyst. Said multi-component catalyst can comprise one, two three, four or more components in addition to palladium. Preferably the additional component can be a transition metal (e.g. a precious metal), or a mixture of transition metals. Preferably the additional component or components are alloyed with the palladium. Alternatively they can be present as a mixture with the palladium. The additional component can be one or more selected from, platinum, gold, ruthenium, rhodium, osmium, iridium, silver, nickel, copper, cobalt, iron, chromium, lead, vanadium or tungsten. Alternatively, the component can be non-metallic, for example carbon, nitrogen, oxygen, sulphur, selenium, tellurium, phosphorous. Preferably the additional component is platinum and/or gold.

In certain embodiments, the catalyst is preferably provided as a two component alloy or mixture for example PdPt or PdAu, a three component alloy or mixture for example PdPtRu, PdPtIr, PdPtAu, a four component alloy or mixture for example PdPtRuIr, PdPtRuOs and/or a five component alloy or mixture for example PdPtRuIrOs. The catalyst may comprise one or more of the two, three, four or five component alloys or mixtures.

The amount of palladium present in relation to the other components can vary from about 10% to about 100% in atomic percentage. The amount of palladium present will depend upon the purpose of the application of the catalytic system. When palladium is the main component, its content will be very high (close to 100 At %). When a high amount of non-palladium components are necessary for the activity of the catalytic system, then the amount of palladium can be lower, for instance at a level of about 20 At % or less, for instance about 10 At %.

The catalyst comprising nanoporous or mesoporous palladium can be prepared by solidification of a metal precursor in the presence of a templating agent.

The templating agent may be one of a number of different compounds or systems of compounds. For example, the templating agent may involve:
a) a template which is a non-ionic surfactant and which forms a liquid crystalline phase under suitable conditions. This liquid crystalline phase directs the deposition of the catalyst, and the catalyst then represents a ‘cast’ of that liquid crystalline phase;
b) the use of a suitable surfactant system resulting in the formation of a micro-emulsion of the reactants which then undergo reaction to produce an interconnected nanoporous or mesoporous structure of the catalyst. For example the synthesis of the mesoporous palladium by mixing two water in oil microemulsions with the same water-surfactant ratio, one containing H₂PdCl₆ and the other containing hydrazine hydroxide;
c) the use of a suitable surfactant and conditions so that the oxide of the catalyst material is produced in a ‘sol-gel’ reaction. Amphiphilic poly(alkylene oxide) block copolymers such as P-123 and Brij®56, can act as structure-directing agents in nonaqueous solutions for organizing network-forming metal species. The resultant mesoporous metal oxides can be further reduced to metal systems;
d) a “hard” template—that is a template which is itself a solid mesoporous or nanoporous material. The voids of a preformed nano- or mesoporous solid, such as mesoporous silica and nanoporous alumina, are impregnated with metal-containing precursor or precursors. Subsequent solidification of these precursors and removal of the ‘hard’ template leads to nano- or meso-porous catalysts. Such ‘hard’ templates may be produced using the previously mentioned approaches (a-c) or may be purchased from a suitable supplier.

In certain embodiments, the solidification process converts the metal precursor to a chemical species which is a solid and which can self-support itself in the absence of the templating agent. After this solidification process, the templating agent is removed by, for example, washing the template out of the system.

The solidification process may involve a chemical transformation of a precursor by for instance the oxidation or reduction of the metal precursor, or a change in the coordinating species around the metal precursor with no change in formal oxidation state.

The reduction process can be carried out by any process known in the art by for example (a) Electrochemically reducing—by poising the electrochemical potential of an electrode within a suitable range so that the metal precursor is reduced to its corresponding metals on the surface of the electrode; or (b) Chemically reducing—by adding a chemical reductant which reduces the metal precursor to its corresponding metal. Suitable chemical reductants are for instance zinc, iron, calcium or magnesium. Alternatively liquid reductants such as formaldehyde solutions; formic acid solutions; or borohydride solutions; or gaseous reductants such as hydrogen, formaldehyde, or boranes can be used.

In certain embodiments, the oxidation process can be carried out by any process known in the art for example (a) Electrochemically oxidising—by poising the electrochemical potential of an electrode within a suitable range so that the metal precursor is oxidised and forms an insoluble compound; or (b) Chemically oxidising—by adding a chemical oxidant which oxidises the metal precursor to an insoluble compound. Suitable chemical oxidants include solutions containing hydrogen peroxide or peroxide salts; perborates, permanganates, chromates or chlorates; or gaseous oxidants such as ozone, chlorine or oxygen.

Another approach to cause solidification of the metal precursor involves the formation of an insoluble chemical species. In one example, this can involve the addition of a compound which changes the pH so that a metal oxide or hydroxide is precipitated. Compounds which can be used to change the pH are acidic or basic materials, especially strong acids and bases for instance sulphuric, nitric or hydrochloric acid or alkali metal hydroxides.

The metal precursor for the purposes of this invention should exhibit a high solubility in the solution containing the templating agent. Such precursors can be the chloro complexes (i.e. metal chlorides) or other halide complexes, or the amino (NH₃), aqua (H₂O), sulfito (SO₃), or cyano (CN) coordinated complexes, or complexes which contain a mixture of one or more of the above ligands. These complexes are particularly preferred for use in aqueous systems. Complexes soluble in non-aqueous solvents include complexes containing acetylacetonate or hexafluoroacetylacetonate, 1,10-phenanthroline and derivatives thereof, 1,5-cyclooctadiene and derivatives thereof, or ethylenediamine and derivatives thereof.

In certain embodiments, the catalyst is placed in contact with an ion-exchange electrolyte. The ion-exchange electrolyte is preferably a cation exchange material having fixed anionic sites. More preferably, the ion-exchange electrolyte is a perfluorinated polymer electrolyte having a pendant acidic group such as a sulphonic acid group teathered to a perfluorinated backbone. Examples of such perfluorinated polymer electrolytes include Nafion® (Dupont), Aciplex® (Asahi Chemical Industry), Flemion® (Asahi Glass Company) or BAM® (Ballard).

Other cation exchange electrolytes which can be used for the purposes of the present invention are electrolytes with pendant acidic groups such as sulphonic or phosphonic acid groups with a hydrocarbon polymer backbone. Examples of such electrolytes include sulfonated or phosphonated forms of polyamide/imide (Kerimid, Torlon®); polychlorotrifluoroethylene, polyetheretherketone (PEEK), polyethersulfone (PES), polyimide, or polyphenylenesulfide, or derivatives thereof.

The ion-exchange electrolytes can also be provided as selected solid-state inorganic proton-conductors, such as derivitised zirconium phosphonates, immobilised and derivatised Keggin and Dawson acids (e.g. phosphomolybdic acid); or hot proton-conductors, such as perovskite-type oxide proton-conducting ceramics.

The ion exchange electrolyte can be provided as a solid in a variety of forms (the bulk electrolyte). For instance it can be provided as a sheet. Alternatively, the ion exchange electrolyte can be provided in a liquid form (the liquid ionomer) which can then form the solid electrolyte after a suitable treatment process. For instance the liquid ionomer may consist of the ion exchange electrolyte material dissolved in some suitable solvent, or it may be the ion-exchanged electrolyte. Alternatively, the liquid ionomer can be a chemical precursor to the said ion-exchange electrolyte. Suitable processes for converting the liquid ionomer to the solid ion-exchange electrolyte can be evaporation of the solvent, changing in temperature of the liquid, exposure to radiation, initiation of cross-linking or polymerisation or a process known in the art.

An especially preferred ion-exchange electrolyte is a perfluorinated ion-exchange polymer consisting of a polytetrafluoroethylene backbone and regular spaced long perfluorovinyl ether pendant side chains terminated by a sulfonate ionic group (Nafion™). One example of the catalytic system provided herein is thus a catalyst comprising nanoporous or mesoporous palladium in contact with Nafion™.

In a second aspect of the invention, there is provided a process for the manufacture of a catalytic system in which a catalyst comprising nanoporous or mesoporous palladium is placed in contact with an ion-exchange electrolyte, so that the catalyst is in ionic contact with that electrolyte.

This ionic contact can result from one or more of
a) simple mechanical force;
b) the use of an adhesive to bind the catalyst to the electrolyte;
c) the use of a liquid ionomer form of the electrolyte to interpenetrate the porous structure of the catalyst and to form a bulk phase of that electrolyte adjacent to the catalyst after suitable treatment; or
d) the use of a liquid ionomer to interpenetrate the porous structure of the catalyst and bind it to a sample of the bulk electrolyte after suitable treatment. This liquid ionomer can be a soluble form of the bulk electrolyte or it may be a liquid ionomer form of a different ion-exchange electrolyte.

In a third aspect of the invention, there is provided a multi-component catalyst comprising nanoporous or mesoporous palladium and one or more of platinum, gold, ruthenium, rhodium, osmium, iridium, silver, nickel, copper, cobalt, iron, chromium, lead, vanadium, tungsten, carbon, nitrogen, oxygen, sulphur, selenium, tellurium or phosphorous. Preferably the multi-component catalyst comprises one or more transition (precious) metals such as platinum, gold, ruthenium, rhodium, osmium, iridium, silver, nickel, copper, cobalt, iron, chronium, lead, vanadium or tungsten, more preferably platinum and/or gold.

In certain embodiments, the multi-component catalyst is provided as a mixture of palladium and one or more additional components, preferably as an alloy. The catalyst is preferably provided as a two component alloy or mixture thereof for example PdPt or PdAu, a three component alloy or a mixture thereof for example PdPtRu, PdPtLr, PdPtAu, a fair component alloy or a mixture thereof, for example PdPtRuLr, PdPtRuOs and/or a five component alloy or mixture thereof, for example PdPtRuLrOs. The multi-component catalyst can comprise one or more of the two, three, four or five component alloys or mixtures.

In certain embodiments, the catalyst comprises 10% to 100% atomic percentage, preferably 20% to 100% atomic percentage.

In a fourth aspect of the invention, there is provided a process for the production of a multi-component catalytic system according to the third aspect of the invention, said process comprising solidifying one or more metal precursors in the presence of a templating agent and then removing said templating agent.

The templating agent may be one of a number of different compounds or systems of compounds. For example, the templating agent may involve:
e) a template which is a non-ionic surfactant and which forms a liquid crystalline phase under suitable conditions. This liquid crystalline phase directs the deposition of the catalyst, and the catalyst then represents a ‘cast’ of that liquid crystalline phase;
f) the use of a suitable surfactant system resulting in the formation of a micro-emulsion of the reactants which then undergo reaction to produce an interconnected nanoporous or mesoporous structure of the catalyst. For example the synthesis of the mesoporous palladium by mixing two water in oil microemulsions with the same water-surfactant ratio, one containing H₂PdCl₆ and the other containing hydrazine hydroxide;
g) the use of a suitable surfactant and conditions so that the oxide of the catalyst material is produced in a ‘sol-gel’ reaction. Amphiphilic poly(alkylene oxide) block copolymers such as P-123 and Brij®56, can act as structure-directing agents in nonaqueous solutions for organizing network-forming metal species. The resultant mesoporous metal oxides can be further reduced to metal systems;
h) a “hard” template—that is a template which is itself a solid mesoporous or nanoporous material. The voids of a preformed nano- or mesoporous solid, such as mesoporous silica and nanoporous alumina, are impregnated with metal-containing precursor or precursors. Subsequent solidification of these precursors and removal of the ‘hard’ template leads to nano- or meso-porous catalysts. Such ‘hard’ templates may be produced using the previously mentioned approaches (a-c) or may be purchased from a suitable supplier.

In certain embodiments, the solidification process converts the metal precursor to a chemical species which is a solid and which can self-support itself in the absence of the templating agent. After this solidification process, the templating agent is removed by, for example, washing the template out of the system.

The solidification process may involve a chemical transformation of a precursor by for instance the oxidation or reduction of the metal precursor, or a change in the coordinating species around the metal precursor with no change in formal oxidation state.

The reduction process can be carried out by any process known in the art by for example (a) Electrochemically reducing—by poising the electrochemical potential of an electrode within a suitable range so that the metal precursor is reduced to its corresponding metals on the surface of the electrode; or (b) Chemically reducing—by adding a chemical reductant which reduces the metal precursor to its corresponding metal. Suitable chemical reductants are for instance zinc, iron, calcium or magnesium. Alternatively liquid reductants such as formaldehyde solutions; formic acid solutions; or borohydride solutions; or gaseous reductants such as hydrogen, formaldehyde, or boranes can be used.

In certain embodiments, the oxidation process can be carried out by any process known in the art for example (a) Electrochemically oxidising—by poising the electrochemical potential of an electrode within a suitable range so that the metal precursor is oxidised and forms an insoluble compound; or (b) Chemically oxidising—by adding a chemical oxidant which oxidises the metal precursor to an insoluble compound. Suitable chemical oxidants include solutions containing hydrogen peroxide or peroxide salts; perborates, permanganates, chromates or chlorates; or gaseous oxidants such as ozone, chlorine or oxygen.

Another approach to cause solidification of the metal precursor involves the formation of an insoluble chemical species. In one example, this can involve the addition of a compound which changes the pH so that a metal oxide or hydroxide is precipitated. Compounds which can be used to change the pH are acidic or basic materials, especially strong acids and bases for instance sulphuric, nitric or hydrochloric acid or alkali metal hydroxides.

The metal precursor for the purposes of this invention should exhibit a high solubility in the solution containing the templating agent. Such precursors can be the chloro complexes (i.e. metal chlorides) or other halide complexes, or the amino (NH₃), aqua (H₂O), sulfito (SO₃), or cyano (CN) coordinated complexes, or complexes which contain a mixture of one or more of the above ligands. These complexes are particularly preferred for use in aqueous systems. Complexes soluble in non-aqueous solvents include complexes containing acetylacetonate or hexafluoroacetylacetonate, 1,10-phenanthroline and derivatives thereof, 1,5-cyclooctadiene and derivatives thereof, or ethylenediamine and derivatives thereof.

In a fifth aspect of the invention, there is provided a process for the oxidation or reduction of organic and/or inorganic molecules comprising contacting said molecules with the catalytic system of the first aspect or with the catalyst of the third aspect.

The organic molecule can preferably comprise from one to about twelve carbon atoms, preferably one to six carbon atoms, more preferably one to four carbon atoms. For example, the organic molecule can be selected from methanol, formic acid, formate, methyl formate, (CH₃O)₂CHO, or (CH₃O)₃CH or Cl molecules such as formaldehyde, and paraformaldehyde, C2-aliphatic alcohols such as ethanol, 1,2-ethan-diol or partially oxidised C2 compounds e.g. ethylene glycol; higher alkyl alcohols and related compounds or their oxidation products e.g. isopropyl alcohol, propylene glycol etc. The organic molecule can also be a sugar, for instance glucose, fructose, or sucrose.

In certain embodiments, the oxidation of the organic and/or inorganic molecules by the process of the fifth aspect allows the use of the catalytic system in a fuel cell wherein the reactant is preferably a fuel for the fuel cell.

Preferred fuels for oxidation can be organic molecules, or mixtures of organic molecules. Alternatively, the fuels can be inorganic molecules, for example hydrogen or hydrazine. Mixtures of organic molecules and inorganic molecules can also be useful.

In certain embodiments, the catalytic system of the first aspect may alternatively be provided as a measuring element in a sensor. The sensor can be used to detect the organic and/or inorganic molecules disclosed above.

In addition suitable analytes can be compounds which would not normally be fully oxidised and which would not normally be suitable as fuels. Such suitable analytes can include urea, thiourea, amino acids, peptides, proteins or carbohydrates.

In certain embodiments, the catalyst or catalytic system described herein can also be used to reduce an oxidant for example oxygen or hydrogen peroxide. The oxidant can be used for example as a reactant for a fuel cell or as an analyte which is to be measured.

In a sixth aspect of the invention, there is provided an electrode comprising the catalytic system of the first aspect and/or the catalyst of the third aspect. Said electrodes can be for use in an electrochemical cell, for example for use in a fuel cell or a sensor.

In a seventh aspect of the invention, there is provided a fuel cell or sensor which comprises a catalytic system of the first aspect, a catalyst of the third aspect or an electrode of the sixth aspect. Preferably, the fuel cell or sensor comprises an electrode of the sixth aspect.

In particular, one or both of a pair of electrodes in a fuel cell or a sensor can comprise the catalytic system of the first aspect and/or the catalyst of the third aspect. It will be appreciated that further electrodes can also be present. Both of the electrodes must be fashioned on the electrolyte such that they are in ionic contact with each other but not in electronic contact. For example, if the electrolyte is a sheet (as is common in fuel cells), then the electrodes would be placed on opposite sides of the sheet. In this example the configuration is used to minimise the distance that any ion has to travel from one electrode to the other.

The configuration of a sensor can be similar to that of a fuel cell as described above. The sensor can be used in detecting the presence or concentration of an organic or inorganic molecule. The structure of a sensor can comprise for example two main electrodes in ionic contact with each other through an electrolyte at least one of which comprises the catalytic system of the invention. Extra electrodes may also be present to function as ‘reference electrodes’ i.e. to provide a stable reference potential.

In an eighth aspect of the invention, there is provided a method for the detection of organic and/or inorganic molecules in a sample comprising contacting said sample with a sensor as defined for the seventh aspect and detecting the current due to oxidation or reduction of the molecules.

All preferred features of each of the aspects of the invention apply to all other aspects mutatis mutandis.

The invention may be put into practice in various ways and a number of specific embodiments will be described by way of example to illustrate the invention with reference to the accompanying drawings.

### EXAMPLES

Example methods of preparing nanoporous or mesoporous Palladium-containing catalysts are described as follows:

### Example 1

### Electrochemical Reduction Method Utilising a Non-Ionic Surfactant that Forms a Liquid Crystalline Phase to Prepare Mesoporous Palladium

The electroplating mixture consists of 12 wt % (NH₄)₂PdCl₄, 47 wt % octaethylene glycol monohexadecyl ether (C₁₆EO₈), 2 wt % heptane and 39 wt % deionized water. The mixture was subjected to three heating-cooling cycles (temperature limits 20 and 80° C.) with vigorous shaking using a vortex mixer until a homogeneous mixture was formed. The mixture was then allowed to stand at room temperature overnight. A conventional three-electrode system utilizing a large-area platinum counterelectrode together with a saturated silver/silver chloride (Ag/AgCl) was used to perform the electrodeposition. Mesoporous palladium films were produced by electrochemical deposition from the electroplating mixture at +0.16 V vs Ag/AgCl onto a gold film. The thickness of the palladium films were controlled by recording the total charge passed during deposition. Typical deposition charge is about 2° C. cm⁻². Following deposition, the palladium films were rinsed repeatedly in acetone and deionized water to remove impurities (surfactant, electrolyte and organic solvents).

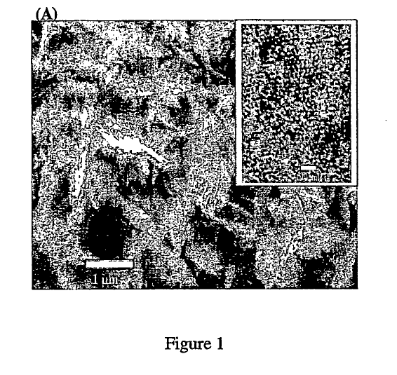

Low resolution SEM images of the film deposited on a gold foil show a smooth, dense and uniform surface. High resolution SEM image exhibit uniform morphology characteristic of leaf-like laminae as illustrated in FIG. 1A. The inset to FIG. 1(A) shows a TEM image of the mesoporous film. The expected nanostructure is clearly seen with a pore diameter of around 3 nm and a pore center-pore center separation of around 6 nm. The specific electrochemical surface area of the film measured using the underpotential Cu stripping technique (Chierchie, T., Mayer, C., Electrochim. Acta 33, 341 (1998)) is about 40 m² g⁻¹. This value corresponding to a surface area/volume ratio of 4.82×10⁸ m² m⁻³ is consistent with the hexagonal nanostructure of the templated film.

### Example 2

### Electrochemical Reduction Method Utilising a Non-Ionic Surfactant that Forms a Liquid Crystalline Phase to Prepare Mesoporous Pd₆₃Pt₃₇ Alloy

Mesoporous Pd₆₃Pt₃₇ alloy material was electroplated from a mixture consisting of 12 wt % Na₂PdCl₆, 14 wt % H₂PtCl₆, 26 wt % H₂O, 2 wt % heptane, 47 wt % surfactant C₁₆EO₈. The mixture was subjected to three heating-cooling cycles (temperature limits 20 and 80° C.) with vigorous shaking using a vortex mixer until a homogeneous mixture was formed. The mixture was then allowed to stand at room temperature overnight. A conventional three-electrode system utilizing a large-area platinum counterelectrode together with a saturated silver/silver chloride (Ag/AgCl) was used to perform the electrodeposition. The Palladium alloy mesoporous film was deposited onto a gold film at a potential of 0.06 V vs Ag/AgCl. Following deposition, the film was rinsed repeatedly in acetone and deionized water to remove impurities (surfactant, electrolyte and organic solvents).

### Example 3

### Chemical Reduction Method Utilising a Non-Ionic Surfactant that Forms a Liquid Crystalline Phase to Produce Mesoporous PtPdRuOs Alloy

A mixture containing 0.364 g Na₂PdCl₆ (Aldrich), 0.50 g H₂PtCl₆.xH2O (Aldrich), 0.202 g RuCl₃.xH2O (Aldrich), 0.30 g Na₂OsCl₆.xH2O (Aldrich), 1.265 g Water, 1.88 g octaethylene glycol monohexadecyl ether non-ionic surfactant (C16EO8, Fluka) was homogeneously mixed with vigorous shaking using a vortex mixer and subjected to three heating-cooling cycles (temperature limits 20 and 80° C.) before being allowed to stand at room temperature for 12 hours. The quaternary catalyst was then precipitated by adding pieces of metallic Zn(Aldrich) to the reactant mixture to chemically reduce the metal salts present in the aqueous domains of the mixture. This reduction process was allowed to continue at room temperature until the mixture became fully black. The black deposit was washed successively with acetone, hydrochloric acid, water and acetone. The recovered product was then dried in an oven at 80° C.

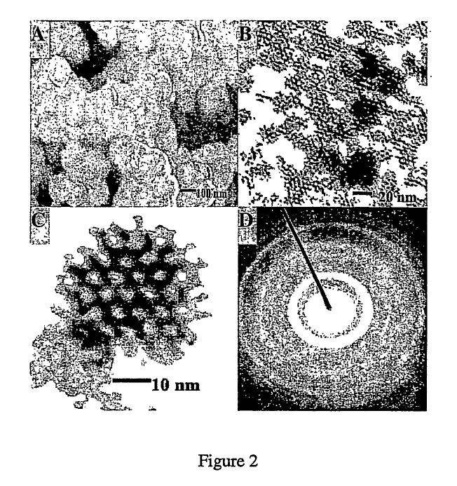

FIG. 2 shows high resolution scanning electron micrograph images of the PtPdRuOs alloy (A). Transmission electron micrograph (TEM) images of PtPdRuOs nanoparticles, (B) and TEM images of a single PtPdRuOs particle showing the well developed porous structure, (C). Electron diffraction patterns of aggregated PtPdRuOs nanoparticles (D)

### Example 4

### Chemical Reduction Method Utilising a Hard Template to Produce Mesoporous Palladium

The template synthesis of mesoporous palladium utilising a ‘hard’ template can be carried out as follows: 5 g aqueous solution of 1 mol dm⁻³ Pd(NH₃)₄Cl₂ (Aldrich) was impregnated into 1 g calcined mesoporous silica SBA-12 powder. After being completely dried at 100° C., the impregnation was repeated three times. Then the SBA-12 sample impregnated with Pd(NH₃)₄Cl₂ was transferred into a glassy tube reactor with two fritted disks. The palladium compound was reduced to Pd using H₂ flowing through the tube while the temperature was increased from 20° C. to 300° C. at 1° C./min, and then maintained at 300° C. for 2 h. The resultant sample was exposed to air after the tube reactor was cooled to room temperature. The Pd/SBA-12 sample was digested in 3 mol dm⁻³ HF solution for 2 h in order to dissolve our the SBA-12. The black product was centrifugatedly filtered, washed with distilled water and dried in a vacuum oven at about 60° C.

### Example 5

### Chemical Reduction Method Utilising a Hard Template to Produce Mesoporous Palladium

In this approach silica powder is used as the hard template and Palladium is supplied as an organo-metallic compound in a fluidized bed reactor using a metal-organic chemical vapor deposition (MOCVD) technique (Jean-Cyrille Hierso, Roselyne Feurer, and Philippe Kalck, Chem. Mater. 2000, 12, 390-399). Four grams of silica powder (sieved between 100 and 200 μm) is supported on a stainless steel mesh with 25 μm openings above a sintered glass frit of (porosity 5) supporting the precursor complex (0.4 g of (η₃-Allyl)(hexafluoroacetylacetonato)palladium). The reactor was evacuated to 0.1 Torr and kept at this pressure for 1 h while the silica powder was heated to 100° C. by ethylene glycol passing through a double envelope in the reactor wall. After this time, the silica powder was heated to 110° C. (the deposition temperature) and the pressure inside the reactor was raised to 30 Torr by the addition of helium (helium flow: 86 mL min⁻¹) at the bottom of the reactor. This pressure was determined so that the velocity of gas through the fluidized bed was approximately four times the minimum bubbling velocity of the powder. The lower portion of the reactor was then heated to 80° C. to sublime the complex into the stream of helium, and a stream of hydrogen was introduced just before the fluidized bed. After 2.5 h, the heating was stopped and the reactor allowed to cool to room temperature. The pressure was returned to atmospheric pressure, and the silica powder was recovered. The Pd/silica sample was washed with 3 mol dm⁻³ HF solution for 2 h. The black product was filtered under centrifugation, washed with distilled water and dried in a vacuum oven at about 60° C.

### Example 6

### Chemical Reduction Method Utilising the Sol-Gel Route to Produce Mesoporous Palladium

1 g of the P-123 (BASF) triblock copolymer was dissolved in 10 g butanol with stirring for 30 min. To this solution, 0.005 mol dm⁻³ PdCl₂ was added with vigorous stirring for 30 min. The resulting sol solution was gelled in an open dish at 60° C. in air for one week. The aged gel sample was then calcined in air at 500° C. for 4 h to remove the block copolymer surfactant species. The resultant palladium oxide was transferred into a glass tube reactor with two fritted disks after it cooled down. The palladium compound was reduced to Pd with H₂ flowing through the tube while the temperature was increased from 20° C. to 300° C. at 1 C/min, and then maintained at 300° C. for 2 h. The resultant sample was exposed to air after the tube reactor was cooled to room temperature.

### Example 7

### Chemical Reduction Method Utilising the Microemulsion Route to Produce Mesoporous Palladium

Microemulsions containing the metallic salts were prepared by adding 1 mol dm⁻³ H₂PdCl₆ to 0.2 mol dm⁻³ Brij®76 in hexane to obtain a ratio of 2/1H₂O/surfactant in the emulsion. Under these conditions the final concentration of the palladium salt is around 5×10⁻³ mol dm⁻³ in the microemulsion In the same way, a microemulsion containing the reductant was prepared by adding an aqueous solution of hydrazine hydroxide to 0.2 mol dm⁻³ Brij®76 solution in hexane. The amount of hydrazine added was adjusted to produce a concentration of 0.05 mol dm⁻³ in the microemulsion. Mixing the two microemulsions produces a colloidal suspension of palladium nanoclusters. The black suspension was filtered under centrifugation, and then washed subsequently with ethanol and water. Finally, the solid product was dried at 80° C.

Example methods of preparing electrode assemblies are described as follows:

### Example 8

### Direct Mechanical Assembly

A conductive electrode with an electrodeposited mesoporous palladium or palladium containing film (for instance prepared by process 1 or 2 above) was pressed into direct contact with a Nafion™ membrane. Utilisation of a small amount of soluble Nafion™ solution on the electrode surface before the interface is formed followed by curing at 120° C. aids the long-term stability of the interface.

### Example 9

### Ink Route Preparation of Mesoporous Electrode-Membrane Assembly

A thin catalyst layer film was sprayed from the inks consisting of mesoporous Pd, 5 wt. % solubilized Nafion® (supplied by DuPont Company), dionized (DI) water, (NH₄)₂C₂O₄ (pore forming additive) and isopropanol. The ratio of mesoporous palladium catalyst to Nafion® is 3:1. The resultant ink was then sprayed by air-brushing over XC-72 carbon coated carbon papers to produce the electrode. After the ink on the carbon paper was dried up, extra Nafion™ solution in iso-propanol was sprayed on the surface of the electrode. The membrane electrode assembly was prepared by hot pressing the electrode onto a Nafion™ 117 membrane at 140° C. and 200 atm for 1.5 min.

### Example 10

### Decal Approach for Producing Catalyst Layer

An ink as described (4) was prepared and uniformly painted on a ptfe decal blank. After the applied inks were dried, the thin film was transferred from the ptfe decal blank to the Na⁺ form of Nafion® 115 membrane by hot-pressing at 160-200° C. and 5-9 MPa for 150 s. After the decal blanks were removed, the hydrophilic film/Nafion® membrane assemblies were ion-exchanged to the protonated form by immersing them in lightly boiling 0.5 M H₂SO₄ solution for about 1 h.

### Example 11

### Nafion™ Impregnation of Film Electrode

An ink was prepared containing ethylene glycol (10 wt %), ptfe suspension (10 wt % ptfe, T30, DuPont), and mesoporous palladium. After mechanical mixing and agitation in an ultrasound bath, the mixture was brushed over a carbon paper/XC72R carbon diffusion layer. The mixture was dried in an oven at 80° C. and then sintered at 360° C. for 20 minutes. After allowing the electrode to cool, it was brushed with 5 wt % Nafion™ in alcohol solution (Aldrich) and this solution was allowed to diffuse into the inner pores of the electrode film for ten minutes at room temperature, followed by drying in air at 80° C. to eliminate residual aliphatic alcohols. Then the electrode was then hot-pressed onto Nafion™ 117 membrane at 160-200° C. and 5-9 MPa for 150 s.

Example results of performance of electrode assemblies

### Example 12

### Superior Performance of Mesoporous or Nanoporous Palladium Containing Catalyst in Contact with an Ion-Exchange Electrolyte

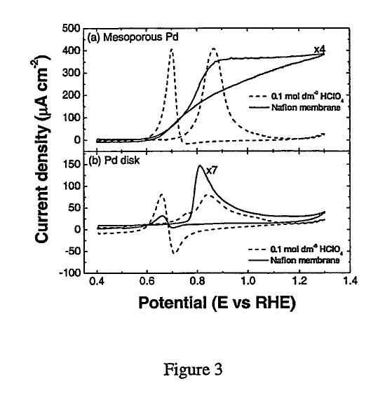

This example shows that when a mesoporous or nanoporous catalyst is in contact with an ion exchange membrane the activity of the system is greater than seen if either of these separate aspects (meso/nano porosity and ion exchange electrolyte) are absent. The mesoporous palladium electrode was produced using as set out in Example 1 and it was assembled according to Example 8. In FIG. 3 methanol oxidation at both mesoporous and polycrystalline palladium electrodes in both an aqueous electrolyte (0.1 mol dm⁻³ HClO₄) and at a exchange membrane (Nafion™) are displayed. The currents are normalised to the total surface area of the catalyst. When the aqueous electrolyte (0.1 mol dm⁻³ HClO₄) is used (dotted lines) a similar response during methanol oxidation is seen independent of the catalyst morphology—namely a sharp anodic peak during the positive-going scan that quickly decays to a low-level current at higher potentials and a similar peak, although shifted in potential, during the negative-going scan. The height of the forward and reverse anodic peaks are very close. However, when Nafion™ is used as the electrolyte, the response is dependent upon the morphology of palladium used. At polycrystalline palladium electrodes, methanol oxidation commences at about 0.75 V, and a sharp anodic peak followed by current decay are seen during the positive-going scan i.e. similar to the response seen for polycrystalline palladium in HClO₄. During the reverse scan only a small anodic peak is produced. In contrast, at the mesoporous palladium electrode, the onset potential of the methanol oxidation is shifted negative by about 150 mV. This represents a significant improvement in performance. Furthermore, the rate of methanol oxidation (i.e. the magnitude of the oxidation current) when the mesoporous catalyst is used is about five times larger than that on the polycrystalline palladium. The rate of methanol oxidation is so high on the mesoporous palladium that a current plateau is seen over 0.85˜1.30 V. Such a plateau is also evident in slow-scan voltammograms at 2 mV s⁻¹ and strongly suggests that the electrode reaction is diffusion controlled at high overpotential. Thus a significant enhancement in catalytic activity is seen when mesoporous palladium is used in contact with a solid polymer electrolyte.

### Example 13

### Oxidation of a Range of Organic Species Using Catalyst Comprising Mesoporous or Nanoporous Palladium in Contact with an Ion-Exchange Electrolyte

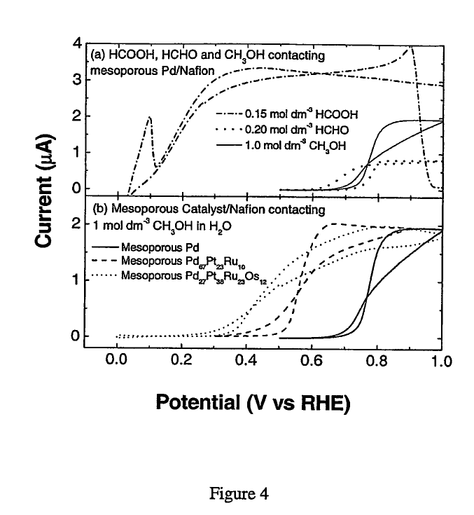

This example shows the performance of mesoporous/nanoporous palladium comprising catalyst in contact with an ion exchange membrane towards the oxidation of various organic compounds and the beneficial effect on activity obtained upon addition of other compounds to the nanoporous/mesoporous palladium catalyst. The results are presented in FIG. 4. The nanoporous/mesoporous palladium catalyst was prepared according to Example 1. The nanoporous/mesoporous PdPtRu was produced according to Example 2 except that some RuCl₃ was added to the templating solution. The PdPtRuOs was produced according to the method described in Example 3. In all cases the electrode assemblies were produced using the ‘direct mechanical assembly’ method (above). The ion exchange electrode used was a Nafion™ 117 membrane.

In FIG. 4(a) the performance of the mesoporous palladium/Nafion system is examined for the oxidation of three different organic compounds of interest in fuel cells and sensors: methanol, formaldehyde and formic acid. only for the oxidation of formaldehyde and formic acid at this kind of composite electrode. The onset potential for the limiting current is around 0.80 and 0.30 V for the oxidation of formaldehyde and formic acid respectively. Therefore, the composite electrode is applicable to formaldehyde and formic acid sensors. The difference in onset potentials above suggests that the sensor electrode has high selectivity for the detection of formaldehyde and formic acid. In all cases a diffusion limiting current or current plateau is found indicating that the rate of oxidation becomes limited by the rate of reactant transport to the catalyst. The low potential at which formic acid oxidation occurs (the reaction commences at around 0 V), and the exceptionally low potential at which the diffusion limited current occurs (0.3V) indicate that formic acid can be decomposed to CO₂ at potentials relevant to fuel cell operations. Mesoporous Palladium is therefore a highly efficient anode electrocatalyst for an ion exchange electrolyte-based formic acidic fuel cell. The mesoporous palladium/Nafion catalytic system is also active for the oxidation of formaldehyde and methanol as shown in the other traces in FIG. 4(a). For both of these other fuels, a limiting current is also observed. These limiting currents are at different values from that seen from formic acid due to the different transport properties and concentration of each of the species being studied.

In FIG. 4(b), the beneficial effect of combining the nanoporous/mesoporous palladium catalyst with other compounds on the oxidation of methanol is described. In all cases a diffusion limiting current is obtained at a suitably high potential, as evidenced by the plateau in activity. This indicates that the performance is limited by the rate at which methanol can reach the catalyst surface and not by the rate of reaction. When platinum and ruthenium is alloyed with the palladium, the activity of the catalyst increases significantly, as shown by the −220 mV shift in the onset potential between the mesoporous palladium and the mesoporous PdPtRu. When Osmium is further added as an alloying element, the onset potential shifts a further −150 mV, indicating a further significant improvement in activity. The quaternary PtRuPdOs/ion exchange electrolyte catalytic system appears to be more active than commercially obtained PtRu catalyst for the methanol oxidation reaction.

### Example 14

### Catalytic System for Inclusion within a Direct Methanol Fuel Cell

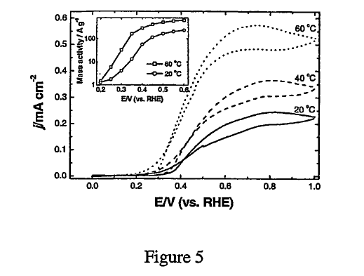

Further evidence of the efficacy of the PtRuPdOs/ion exchange electrolyte catalytic system for the oxidation of methanol is provided in FIG. 5 which shows the performance of the mesoporous Pd₂₇Pt₃₈Ru₂₃Os₁₂/Nafion catalytic system as a function of temperature. Increasing the temperature from 20° C. to 60° C. leads to a shift of −100 mV in the onset potential. Increasing the temperature also increases the limiting current, as higher temperatures improve the mass transport characteristics of methanol in the ion exchange electrolyte. Displayed inset of FIG. 5 is the mass activity of the catalyst. At 0.3 V, and activity of over 30 A g⁻¹ is achievable at 60° C.

### Example 15

### Preparation of a Methanol Sensor

Owing to a linear relation between the diffusion-limiting current and the concentration of active reactants, the nanoporous/mesoporous palladium catalytic system can be directly used as a methanol sensor. This type of sensor avoids the need for an aqueous electrolyte. The sensor incorporates the catalytic system and a method to pass the analyte containing the unknown concentration of methanol over the catalytic system. The response of the limiting current to variations in the concentration of methanol is determined by the sorption isotherm of methanol from the feed solution into the electrolyte. Methanol is more likely to dissolve in the microvoids of the membrane rather than its polytetrafluoroethylene backbone. If the sorption of methanol into the microvoids dominates, a Langmuir sorption isotherm would be expected.

The dependence of the limiting current upon the methanol concentration of the feed solution can be given as:

$${I}_{d} = \frac{{I}_{d}^{max} kc}{1 + kc} \qquad ( 1 )$$

where I_{d} and I_{d}^{max} are the diffusion limited current at a methanol concentration c and at the maximum concentration of methanol in the membrane. k is the Langmuir affinity constant. Thus it is possible to calculate an unknown methanol concentration in water by measuring the limiting current and solving equation (1) for c, once the parameters I_{d}^{max} and k are known for a specific configuration.

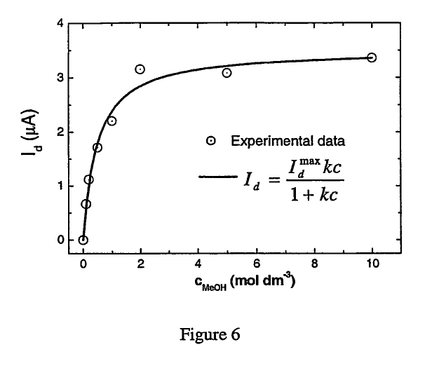

Displayed in FIG. 6 is a plot of limiting current versus methanol concentration (in water) for a mesoporous palladium catalyst/Nafion™ membrane catalyst system. This catalyst system is the same as that used in Example 13. The limiting current increases with methanol concentration in water reaching a maximum at about 2 mol dm⁻³ of methanol in water. Fitting the curve in FIG. 6 gives I_{d}^{max}=3.36 μA and k=2.0 with a confidence of 98.5%. Thus this system could now be used to measure the unknown methanol concentration in water by measuring the limiting current and solving equation (1) for c using the values of I_{d}^{max} and k displayed above.

1. A catalytic system comprising a catalyst comprising nanoporous or mesoporous palladium and an ion-exchange electrolyte.

2. A catalytic system as claimed in claim 1 wherein the catalyst further comprises one or more of platinum, gold, ruthenium, rhodium, osmium, iridium, silver, nickel, copper, cobalt, iron, chromium, lead, vanadium or tungsten.

3. A catalytic system as claimed in any one of claims 1 to 2 wherein the catalyst is Pd, PdPt, PdAu, PdPtRu, PdPtIr, PdPtAu, PdPtRuIr, PdPtRuOs or PdPtRuIrOs.

4. A catalytic system as claimed in any one of claims 1 to 2 wherein the ion-exchange electrolyte is a cation exchange electrolyte.

5. A multi-component catalyst comprising a nanoporous or mesoporous palladium and one or more of platinum, gold, ruthenium, rhodium, osmium, iridium, silver, nickel, copper, cobalt, iron, chromium, lead, vanadium, tungsten, carbon, nitrogen, oxygen, sulphur, selenium, tellurium or phosphorous.

6. A process for the production of a catalyst as claimed in claim 5, said process comprising solidifying one or more metal precursors in the presence of a templating agent and then removing the templating agent.

7. A process for the oxidation or reduction of inorganic and/or organic molecules comprising contacting said molecules with the catalytic system as claimed in claim 1 or 2, or a multi-component catalyst comprising a nanoporous or mesoporous palladium and one or more of platinum, gold, ruthenium, rhodium, osmium, iridium, silver, nickel, copper, cobalt, iron, chromium, lead, vanadium, tungsten, carbon, nitrogen, oxygen, sulphur, selenium, tellurium or phosphorous.

8. A process as claimed in claim 7 wherein the organic molecule has from one to twelve carbon atoms.

9. A process as claimed in claim 7 wherein the organic molecule is methanol.

10. (canceled)

11. A process for the manufacture of a catalytic system as claimed in claim 1 or 2 comprising contacting the catalyst with the ion-exchange electrolyte.

12. An electrode comprising a catalytic system as claimed in claim 1 or 2, or a multi-component catalyst comprising a nanoporous or mesoporous palladium and one or more of platinum, gold, ruthenium, rhodium, osmium, iridium, silver, nickel, copper, cobalt, iron, chromium, lead, vanadium, tungsten, carbon, nitrogen, oxygen, sulphur, selenium, tellurium or phosphorous.

13. A fuel cell comprising an electrode as claimed in claim 12.

14. A sensor comprising an electrode as claimed in claim 12.

15. A method for the detection of organic and/or inorganic molecules in a sample comprising contacting said sample with a sensor as claimed in claim 14 and detecting the current due to the oxidation or reduction of the molecules.

16-21. (canceled)

22. The catalytic system of claim 3 wherein the ion-exchange electrolyte is a cation exchange electrolyte.

23. The process of claim 7 wherein, in the catalytic system, the catalyst is Pd, PdPt, PdAu, PdPtRu, PdPtIr, PdPtAu, PdPtRuIr, PdPtRuOs or PdPtRuIrOs.

24. The process of claim 7 wherein, in the catalytic system, the ion-exchange electrolyte is a cation exchange electrolyte.

25. The process of claim 8 wherein the organic molecule is methanol.

26. The process of claim 11 wherein, in the catalytic system, the catalyst is Pd, PdPt, PdAu, PdPtRu, PdPtIr, PdPtAu, PdPtRuIr, PdPtRuOs or PdPtRuIrOs.

27. The process of claim 11 wherein, in the catalytic system, the ion-exchange electrolyte is a cation exchange electrolyte.

28. The electrode of claim 12 wherein, in the catalytic system, the catalyst is Pd, PdPt, PdAu, PdPtRu, PdPtIr, PdPtAu, PdPtRuIr, PdPtRuOs or PdPtRuIrOs.

29. The electrode of claim 12 wherein, in the catalytic system, the ion-exchange electrolyte is a cation exchange electrolyte.

30. The fuel cell of claim 13 wherein, in the electrode comprising the catalytic system, the catalyst is Pd, PdPt, PdAu, PdPtRu, PdPtIr, PdPtAu, PdPtRuIr, PdPtRuOs or PdPtRuIrOs.

31. The fuel cell of claim 13 wherein, in the electrode comprising the catalytic system, the ion-exchange electrolyte is a cation exchange electrolyte.

32. The sensor of claim 14 wherein, in the electrode comprising the catalytic system, the catalyst is Pd, PdPt, PdAu, PdPtRu, PdPtIr, PdPtAu, PdPtRuIr, PdPtRuOs or PdPtRuIrOs.

33. The sensor of claim 14 wherein, in the electrode comprising the catalytic system, the ion-exchange electrolyte is a cation exchange electrolyte.
